(19) United States
(12) Patent Application Publication
(10) Pub. No.: US 2013/0323563 A1
(43) Pub. Date: Dec. 5, 2013

(54) POUCH TYPE SECONDARY BATTERY

(71) Applicant: Soomi Eo, Yongin-si (KR)

(72) Inventor: Soomi Eo, Yongin-si (KR)

(21) Appl. No.: 13/610,770

(22) Filed: Sep. 11, 2012

(30) Foreign Application Priority Data
May 29, 2012 (KR) 10-2012-0056961

(51) Int. Cl. H01M 10/50; H01M 2/30; H01M 2/08

(52) U.S. Cl. 429/120

(57) ABSTRACT

A pouch type secondary battery includes electrode assemblies each having a pair of long side surfaces and a pair of short side surfaces each connecting two side portions of the long side surfaces, one of the pair of long side surfaces of one of the electrode assemblies and another one of the pair of long side surfaces of another one of the electrode assemblies facing each other, a pouch case accommodating the electrode assemblies, electrode tabs electrically connected to the electrode assemblies, and exposed out of the pouch case, and a heat dissipating member including at least one heat dissipating plate between the one of the pair of long side surfaces of the one of the electrode assemblies and the other one of the pair of long side surfaces of the other one of the electrode assemblies, and a heat dissipating lead extending from the heat dissipating plate.

### CROSS-REFERENCE TO RELATED PATENT APPLICATION

This application claims priority to and the benefit of Korean Patent Application No. 10-2012-0056961, filed on May 29, 2012, in the Korean Intellectual Property Office, the disclosure of which is incorporated herein in its entirety by reference.

### BACKGROUND

1. Field

One or more embodiments relate to a pouch type secondary battery.

2. Description of the Related Art

Secondary batteries are classified into cylindrical secondary batteries, prismatic secondary batteries, or pouch secondary batteries (pouch type secondary batteries), according to the appearances of the cases for accommodating the electrode assemblies of the secondary batteries.

A pouch type secondary battery includes an electrode assembly and a pouch case enveloping and sealing the electrode assembly. The electrode assembly is formed by stacking or winding a negative electrode plate, a positive electrode plate, and a separator disposed therebetween. Electrode tabs are welded to the positive and negative electrode plates, respectively, and the electrode assembly is accommodated within the pouch case with the electrode tabs exposed out of the pouch case.

A typical pouch case includes: a case main body having a space for accommodating an electrode assembly; and a case cover extending from an end of the case main body to cover the case main body. The case cover is coupled to the case main body by sealing the case cover on a flange disposed at the edge of the case main body.

In general, when a battery pack is formed using a single pouch type secondary battery, a single protective circuit is connected to the pouch type secondary battery. A single protective circuit is connected to two or more batteries in a notebook computer requiring a high capacity battery pack that is different from the battery pack using the single pouch type secondary battery. As such, when a single protective circuit is connected to two or more pouch type batteries, the pouch type batteries are vertically stacked and attached to each other with a double-sided adhesive tape therebetween.

As such, since a typical high capacity pouch type battery pack includes a plurality of batteries in surface contact with each other and adhered to each other to form a stacked structure, high temperature heat generated from the batteries is transferred therebetween without heat loss, thereby increasing the temperature of the entire battery pack.

### SUMMARY

An aspect of an embodiment of the present invention is directed toward a pouch secondary battery (a pouch type secondary battery) having improved heat dissipating performance.

According to an embodiment, a pouch type secondary battery includes: a plurality of electrode assemblies each having a pair of long side surfaces and a pair of short side surfaces each connecting two side portions of the long side surfaces, one of the pair of long side surfaces of one of the electrode assemblies and another one of the pair of long side surfaces of another one of the electrode assemblies facing each other; a pouch case accommodating the electrode assemblies; a plurality of electrode tabs electrically connected to the electrode assemblies, and exposed out of the pouch case; and a heat dissipating member comprising at least one heat dissipating plate disposed between the one of the pair of long side surfaces of the one of the electrode assemblies and the other one of the pair of long side surfaces of the other one of the electrode assemblies, and a heat dissipating lead extending from the heat dissipating plate.

The pouch type secondary battery may further include a heat sink, and the heat dissipating lead is configured to be connected to the heat sink disposed out of the pouch case.

The electrode assemblies may include: a first electrode assembly comprising neighboring ones of the electrode assemblies; and a second electrode assembly comprising other neighboring ones of the electrode assemblies.

The pouch case may include: a first case having an opening and an inner space for accommodating the first electrode assembly; a first sealing part extending outward along a periphery of an end of the first case; a second case having an opening and an inner space for accommodating the second electrode assembly; and a second sealing part extending outward along a periphery of an end of the second case, wherein ends of the first and second sealing parts are connected to each other through a connecting part, and are bent such that the first sealing part corresponds to and faces the second sealing part.

The heat dissipating plate may have substantially the same area as that of an imaginary plane sharing an outer contour of the first or second sealing part.

The electrode tabs connected to the first electrode assembly and the electrode tabs connected to the second electrode assembly may be exposed in the same direction, and be electrically connected to each other such that the first electrode assembly and the second electrode assembly are connected to each other in parallel.

The electrode tabs connected to the first electrode assembly may be exposed in a direction different from that of the electrode tabs connected to the second electrode assembly.

The heat dissipating plate may have substantially the same area as that of the long side surface of each of the electrode assemblies.

A lead out direction of the electrode tabs may be different from an extension direction of the heat dissipating lead.

The heat dissipating plate may tightly contact the one of the pair of long side surfaces of the one of the electrode assemblies and the other one of the pair of long side surfaces of the other one of the electrode assemblies.

The heat dissipating plate may be formed of copper, aluminum, or an alloy thereof, and be coated with an insulating material.

The heat dissipating lead may be exposed out of the pouch case.

According to another embodiment, a pouch type secondary battery includes: a plurality of electrode assemblies each having a pair of long side surfaces and a pair of short side surfaces each connecting two side portions of the long side surfaces, one of the pair of long side surfaces of one of the electrode assemblies and a corresponding one of the pair of long side surfaces of a neighboring one of the electrode assemblies facing each other; a pouch case accommodating the electrode assemblies; a plurality of electrode tabs electrically connected to the electrode assemblies, and exposed out of the pouch case; and a heat dissipating member comprising at least one heat dissipating plate disposed between the one of the pair of long side surfaces of the one of the electrode assemblies and the other one of the pair of long side surfaces of the other one of the electrode assemblies, and a heat dissipating lead connecting the heat dissipating plate to at least one of the electrode tabs.

The electrode assemblies may include: a first electrode assembly comprising neighboring ones of the electrode assemblies; and a second electrode assembly comprising other neighboring ones of the electrode assemblies.

The pouch case may include: a first case having an opening and an inner space for accommodating the first electrode assembly; a first sealing part extending outward along a periphery of an end of the first case; a second case having an opening and an inner space for accommodating the second electrode assembly; and a second sealing part extending outward along a periphery of an end of the second case, wherein ends of the first and second sealing parts are connected to each other through a connecting part, and are bent such that the first sealing part corresponds to and faces the second sealing part.

The electrode tabs connected to the first electrode assembly and the electrode tabs connected to the second electrode assembly may be exposed in the same direction, and be electrically connected to each other such that the first electrode assembly and the second electrode assembly are connected to each other in parallel.

The electrode tabs connected to the first electrode assembly may be exposed in a direction different from that of the electrode tabs connected to the second electrode assembly.

The heat dissipating member may be smaller in area than that of the long side surface of each of the electrode assemblies.

The heat dissipating member may tightly contact the one of the pair of long side surfaces of the one of the electrode assemblies and the other one of the pair of long side surfaces of the other one of the electrode assemblies.

The heat dissipating member may be formed of copper, aluminum, or an alloy thereof, and be coated with an insulating material.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1 is a perspective view illustrating a pouch secondary battery (a pouch type secondary battery) according to an embodiment;

FIG. 2 is an exploded perspective view illustrating the pouch type secondary battery of FIG. 1;

FIG. 3 is a cross-sectional view taken along line I-I′ of FIG. 1;

FIGS. 4 to 7 are plan views illustrating the sizes of heat dissipating plates and lead out directions of electrode tabs and heat dissipating leads according to embodiments;

FIG. 8 is a plan view illustrating a pouch type secondary battery according to another embodiment; and

FIG. 9 is a plan view illustrating a modified example of the lead out directions of the electrode tabs of FIG. 8.

### DETAILED DESCRIPTION

Korean Patent Application No. 10-2012-0056961 filed on May 29, 2012, in the Korean Intellectual Property Office, and entitled: “POUCH TYPE SECONDARY BATTERY” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Hereinafter, a pouch secondary battery (a pouch type secondary battery) will now be described according to an embodiment.

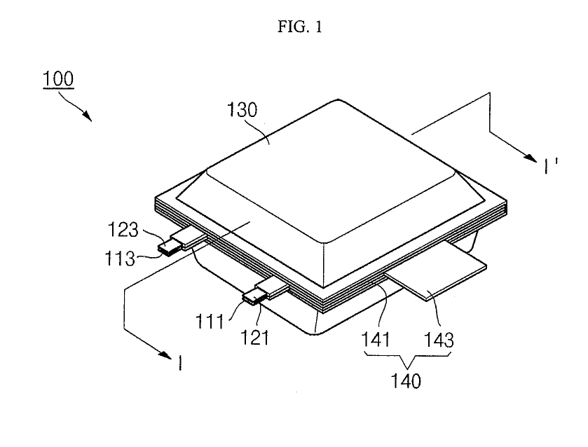

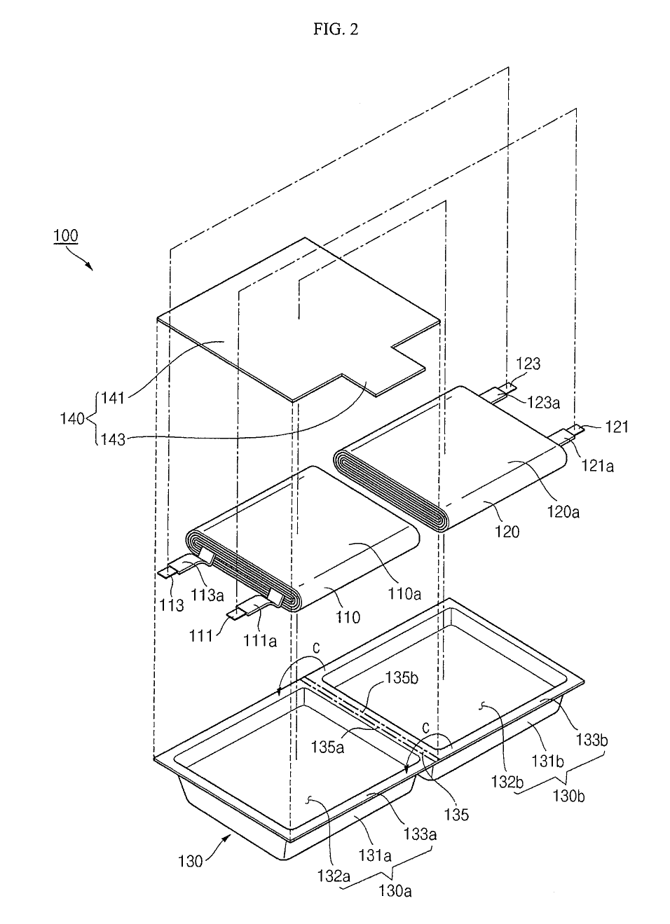

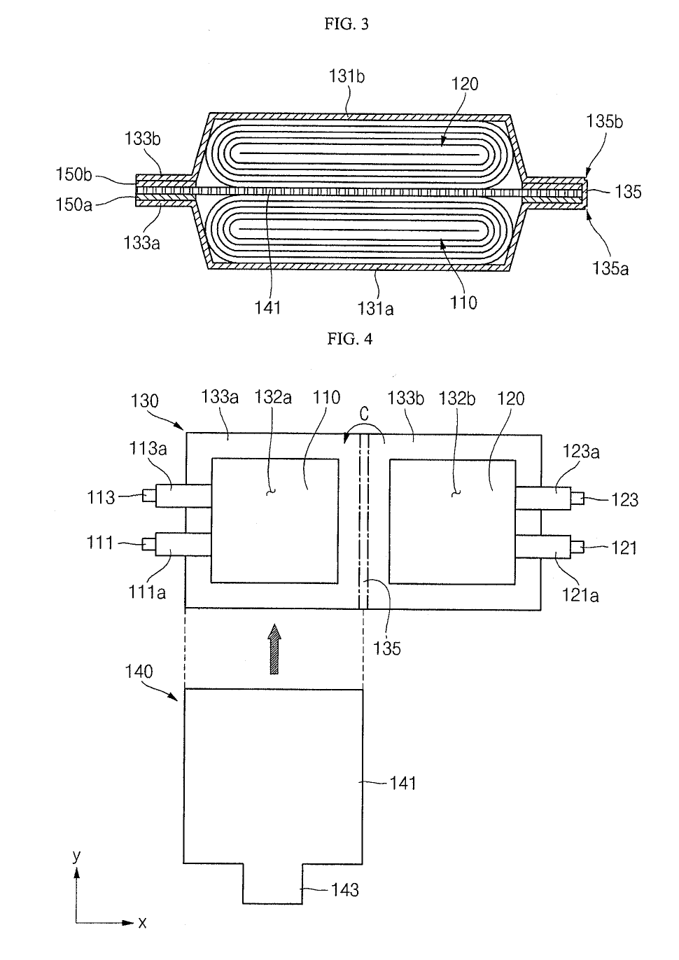

FIG. 1 is a perspective view illustrating a pouch type secondary battery according to an embodiment. FIG. 2 is an exploded perspective view illustrating the pouch type secondary battery of FIG. 1. FIG. 3 is a cross-sectional view taken along line I-I′ of FIG. 1.

Referring to FIGS. 1 and 3, a pouch type secondary battery 100 according to an embodiment includes a plurality of electrode assemblies, a plurality of electrode tabs, a pouch case 130, and at least one heat dissipating member 140.

Each of the electrode assemblies has an approximately rectangular parallelepiped shape, and may have a pair of long side surfaces and a pair of short side surfaces each connecting two side portions of the long side surfaces. The electrode assemblies may have the same size and capacity. The electrode assemblies may include a first electrode assembly group including neighboring ones of the electrode assemblies, and a second electrode assembly group including another neighboring ones of the electrode assemblies. The electrode tabs include a plurality of first electrode tabs and a plurality of second electrode tabs, which may be connected to the electrode assemblies, respectively.

For convenience in description, each of the first and second electrode assembly groups is exemplified as a single electrode assembly. In particular, the first electrode assembly group is exemplified as a first electrode assembly 110, and the second electrode assembly group is exemplified as a second electrode assembly 120. In addition, the electrode tabs are represented by first and second electrode tabs 111 and 113 connected to the first electrode assembly 110, and first and second electrode tabs 121 and 123 connected to the second electrode assembly 120.

The first electrode assembly 110 is formed by winding or stacking a first electrode plate, a separator, and a second electrode plate. The first electrode plate may function as a positive electrode or a negative electrode, and the second electrode plate may have the opposite pole (polarity) to that of the first electrode plate.

The first electrode plate is formed by applying a first electrode active material such as a transition metal oxide on a first electrode collector plate formed of a metal foil (such as an aluminum foil), but materials used to form the first electrode plate are not limited thereto.

The second electrode plate is formed by applying a second electrode active material (such as graphite or carbon) on a second electrode collector plate formed of a metal foil (such as a copper or nickel foil), but materials used to form the second electrode plate are not limited thereto.

The separator is disposed between the first electrode plate and the second electrode plate to prevent short circuiting and allow the movement of transition metal ions, and may be formed of poly ethylene, poly propylene, or a combined film of poly propylene and poly ethylene, but is not limited thereto.

The first electrode tab 111 is electrically connected to the first electrode plate of the first electrode assembly 110, and the second electrode tab 113 is electrically connected to the second electrode plate of the first electrode assembly 110.

The first and second electrode tabs 111 and 113 of the first electrode assembly 110 are protruded and exposed out of the pouch case 130. The first and second electrode tabs 111 and 113 may include first and second insulating tapes 111a and 113a, and be wrapped therewith, respectively. The first and second insulating tapes 111a and 113a may prevent (protect from) an unnecessary electrical short circuit between the heat dissipating member 140 and the first and second electrode tabs 111 and 113. When the heat dissipating member 140 is coated with an insulating material, the first and second insulating tapes 111a and 113a may be unnecessary.

The first electrode assembly 110 has an approximately rectangular parallelepiped shape, and may have a pair of long side surfaces and a pair of short side surfaces each connecting two side portions of the long side surfaces. Hereinafter, a long side surface 110a of FIG. 2 will be representatively exemplified as one of the long side surfaces of the first electrode assembly 110.

The electrode assembly (e.g., 110 or 120) is formed by winding or stacking a first electrode plate, a separator, and a second electrode plate. The first electrode plate may function as a positive electrode or a negative electrode, and the second electrode plate may have the opposite pole to that of the first electrode plate.

The first electrode plate is formed by applying a first electrode active material (such as a transition metal oxide) on a first electrode collector plate formed of a metal foil (such as an aluminum foil), but materials used to form the first electrode plate are not limited thereto.

The second electrode plate is formed by applying a second electrode active material (such as graphite or carbon) on a second electrode collector plate formed of a metal foil (such as a copper or nickel foil), but materials used to form the second electrode plate are not limited thereto.

The separator is disposed between the first electrode plate and the second electrode plate to prevent (protect from) short circuiting and allow the movement of transition metal ions, and may be formed of poly ethylene, poly propylene, or a combined film of poly propylene and poly ethylene, but is not limited thereto.

The first electrode tab 121 is electrically connected to the first electrode plate of the second electrode assembly 120, and the second electrode tab 123 is electrically connected to the second electrode plate of the second electrode assembly 120.

The first and second electrode tabs 121 and 123 of the second electrode assembly 120 are protruded and exposed out of the pouch case 130. The first and second electrode tabs 121 and 123 may include first and second insulating tapes 121a and 123a, and be wrapped therewith, respectively. The first and second insulating tapes 121a and 123a may prevent (protect from) an unnecessary electrical short circuit between the heat dissipating member 140 and the first and second electrode tabs 121 and 123. When the heat dissipating member 140 is coated with an insulating material, the first and second insulating tapes 121a and 123a may be unnecessary.

The second electrode assembly 120 has an approximately rectangular parallelepiped shape, and may have a pair of long side surfaces and a pair of short side surfaces each connecting two side portions of the long side surfaces. Hereinafter, a long side surface 120a of FIG. 2 will be representatively exemplified as one of the long side surfaces of the second electrode assembly 120.

The pouch case 130 may include a first pouch case 130a and a second pouch case 130b.

The first pouch case 130a may include a first case 131a and a first sealing part 133a. The first case 131a has an approximately rectangular parallelepiped shape, and includes an inner space to accommodate the first electrode assembly 110, and a first opening part 132a having an opening. Thus, the first case 131a can accommodate the first electrode assembly 110 through the first opening part 132a. The first sealing part 133a is provided in the form of a flange extending outward along the periphery of an end of the first case 131a.

The second pouch case 130b may include a second case 131b and a second sealing part 133b. The second case 131b has an approximately rectangular parallelepiped shape, and includes an inner space to accommodate the second electrode assembly 120, and a second opening part 132b having an opening. Thus, the second case 131b can accommodate the second electrode assembly 120 through the second opening part 132b. The second sealing part 133b is provided in the form of a flange extending outward along the periphery of an end of the second case 131b.

An end 135a of the first sealing part 133a is connected to an end 135b of the second sealing part 133b through a connecting part 135. The ends 135a and 135b may be bent such that a surface of the first sealing part 133a overlaps or corresponds to (and faces) a surface of the second sealing part 133b. To this end, the ends 135a and 135b may have bending grooves, respectively. Thus, the second pouch case 130b can cover the first pouch case 130a. Alternatively, the first pouch case 130a may cover the second pouch case 130b. That is, the first pouch case 130a is horizontally connected (e.g., connected along the connecting part 135) to the second pouch case 130b, and a connected portion thereof is foldable (e.g., the portion of each of the ends 135a and 135b connected to the connecting part 135), so that the first pouch case 130a and the second pouch case 130b can overlap each other. Thus, after the first and second electrode assemblies 110 and 120 are accommodated in the first and second pouch cases 130a and 130b, when the pouch case 130 is folded, the long side surface 110a of the first electrode assembly 110 faces the long side surface 120a of the second electrode assembly 120. At this point, the heat dissipating member 140 may be located between the long side surfaces 110a and 120a, which will be described later in more detail.

The long side surfaces 110a and 120a of the first and second electrode assemblies 110 and 120 may have a square shape with identical four sides, and side walls of the first and second pouch cases 130a and 130b may have the same length. Thus, a lead out direction of the first and second electrode tabs 111 and 113 of the first electrode assembly 110 and the first and second electrode tabs 121 and 123 of the second electrode assembly 120 out of the pouch case 130 can be efficiently changed, which will be described later in more detail.

Substantially, electrolyte as well as the first and second electrode assemblies 110 and 120 is accommodated in the pouch case 130. The electrolyte may include: an organic solvent such as ethylene carbonate (EC), propylene carbonate (PC), diethyl carbonate (DEC), ethyl methyl carbonate (EMC), or dimethyl carbonate (DMC); and a lithium salt such as LiPF₆ or LiBF₄. The electrolyte may be liquid, solid, or gel.

The heat dissipating member 140 may include a heat dissipating plate 141 and a heat dissipating lead 143.

The heat dissipating plate 141 has an approximately tetragonal plate shape, and the heat dissipating lead 143 may horizontally extend from an end of the heat dissipating plate 141. The heat dissipating plate 141 may have a square shape, but is not limited thereto. The heat dissipating member 140 may be formed of copper, aluminum, or an alloy thereof, and be coated with an insulating material.

The heat dissipating plate 141 may have an area that is the same as that of an imaginary plane sharing the outer contour of the first or second sealing part 133a or 133b.

The heat dissipating plate 141 may have an area different from that of the imaginary plane, provided that the heat dissipating plate 141 covers the first or second sealing part 133a or 133b. Thus, when the pouch type secondary battery 100 is completed assembled, the central portion of the heat dissipating plate 141 may be disposed between the long side surface 110a and the long side surface 120a, and the edge portion thereof may be disposed between the first and second sealing parts 133a and 133b. At this point, the heat dissipating lead 143 is exposed out of the pouch case 130.

The heat dissipating plate 141 may have an area that is the same as that of the long side surface 110a or 120a, which will be described later in more detail.

Hereinafter, a method and process of assembling the pouch type secondary battery 100 will now be described.

When the pouch case 130 is opened, the first and second electrode assemblies 110 and 120 may be accommodated in the first and second cases 131a and 131b, respectively. At this point, a lead out direction of the first and second electrode tabs 111 and 113 may be opposite to that of the first and second electrode tabs 121 and 123 with respect to the connecting part 135.

Then, a side surface of the heat dissipating member 140 may be disposed on the first case 131a. At this point, the central portion of the side surface of the heat dissipating plate 141 contacts the long side surface 110a of the first electrode assembly 110, and the edge portion thereof contacts the first sealing part 133a. In addition, a lead out direction of the heat dissipating lead 143 may be different from the lead out directions of the electrode tabs 111, 113, 121 and 123. At this point, as illustrated in FIG. 3, a first cast polypropylene (CCP) layer 150a may be formed between the first sealing part 133a and the edge portion of the side surface of the heat dissipating plate 141 through a primary sealing process. (Alternatively, the heat dissipating member 140 may be disposed on the second case 131b first. In this case, the central portion of another surface of the heat dissipating plate 141 contacts the long side surface 120a of the second electrode assembly 120, and the edge portion thereof contacts the second sealing part 133b.)

Next, the second pouch case 130b accommodating the second electrode assembly 120 is bent in a direction C to cover the first pouch case 130a. At this point, the central portion of the side surface of the heat dissipating plate 141 contacts the long side surface 120a, and the edge portion thereof contacts the second sealing part 133b. In addition, a second CCP layer 150b may be formed between the second sealing part 133b and the edge portion of the side surface of the heat dissipating plate 141 through a secondary sealing process.

The electrode tabs 111, 113, 121, and 123 may be exposed in the same direction from the pouch case 130 as illustrated in FIG. 1, and may be electrically connected to each other such that the first and second electrode assemblies 110 and 120 are connected to each other in parallel. More particularly, the first electrode tab 111 of the first electrode assembly 110 may correspond in position to the first electrode tab 121 of the second electrode assembly 120, and the second electrode tab 113 of the first electrode assembly 110 may correspond in position to the second electrode tab 123 of the second electrode assembly 120. In this state, the first electrode tab 111 of the first electrode assembly 110 is electrically connected to the first electrode tab 121 of the second electrode assembly 120, and the second electrode tab 113 of the first electrode assembly 110 is electrically connected to the second electrode tab 123 of the second electrode assembly 120. To this end, resistance welding may be used.

As described above, a lead out direction of the first and second electrode tabs 111 and 113 from the pouch case 130 may be opposite to or the same as that of the first and second electrode tabs 121 and 123, which will be described later in more detail.

Thus, the heat dissipating plate 141 directly and tightly contacts the first and second electrode assemblies 110 and 120 within the pouch case 130, so that heat can be more efficiently transferred from the first and second electrode assemblies 110 and 120 to the heat dissipating plate 141. The heat transferred to the heat dissipating plate 141 is emitted to the outside of the pouch type secondary battery 100 through the heat dissipating lead 143, thus improving heat dissipating efficiency. Furthermore, the pouch type secondary battery 100 may include a heat sink that is disposed outside the pouch case 130, and the heat dissipating lead 143 is configured to be connected to this heat sink, thus further improving the heat dissipating efficiency.

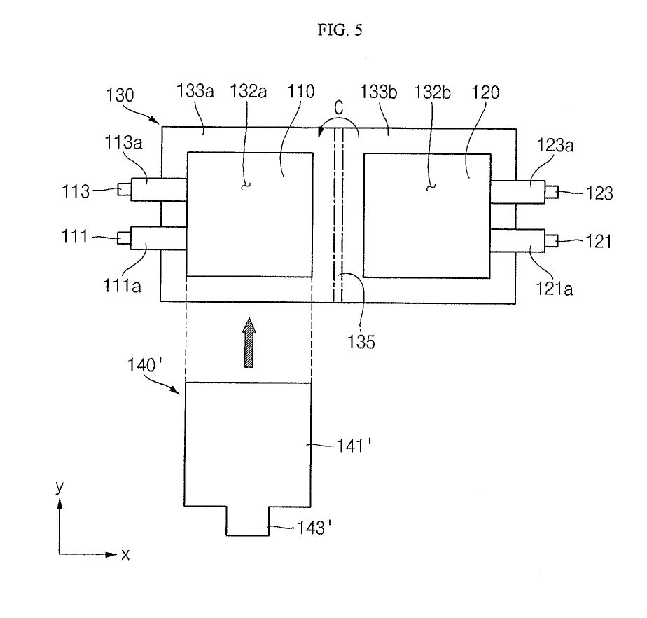

FIGS. 4 to 7 are plan views illustrating the sizes of heat dissipating plates and lead out directions of electrode tabs and heat dissipating leads according to embodiments.

FIG. 4 is an exploded plan view illustrating a configuration of the pouch type secondary battery 100 of FIGS. 1 to 3. Referring FIG. 4, the heat dissipating plate 141 is the same in size as the pouch case 130, and the electrode tabs 111, 113, 121, and 123 have the same final lead out direction that is different from that of the heat dissipating lead 143.

When the first and second electrode assemblies 110 and 120 are accommodated in the pouch case 130, a lead out direction of the first and second electrode tabs 111 and 113 may be opposite to that of the first and second electrode tabs 121 and 123 with respect to the connecting part 135. For example, the lead out direction of the first and second electrode tabs 111 and 113 may be a negative x (−x) axis direction, and the lead out direction of the first and second electrode tabs 121 and 123 may be a positive x (+x) axis direction.

After that, when the pouch case 130 is folded in the direction C, the first and second electrode tabs 111 and 113 and the first and second electrode tabs 121 and 123 may have the same lead out direction. For example, the lead out direction of the electrode tabs 111, 113, 121, and 123 may be the −x axis direction. At this point, the heat dissipating lead 143 may have a lead out direction that is different from that of the electrode tabs 111, 113, 121, and 123. For example, the lead out direction of the heat dissipating lead 143 may be a negative y (−y) axis direction as illustrated in FIG. 4.

Referring FIG. 5, a heat dissipating member 140′ is different in size from the heat dissipating member 140 of FIG. 4. In more detail, a heat dissipating plate 141′ has an area that is the same as that of a long side surface of a first or second electrode assembly 110 or 120. Like in FIG. 4, a heat dissipating lead 143′ has a lead out direction that is different from that of electrode tabs 111, 113, 121, and 123, and that may be the −y axis direction. In this case, the heat dissipating plate 141′ directly and tightly contacts long side surfaces of the first and second electrode assemblies 110 and 120, and is not disposed between first and second sealing parts 133a and 133b.

Referring FIG. 6, unlike in FIG. 4, a final lead out direction of first and second electrode tabs 111 and 113 of a first electrode assembly 110 is different from that of first and second electrode tabs 121 and 123 of a second electrode assembly 120.

When the first and second electrode assemblies 110 and 120 are accommodated in a pouch case 130, a lead out direction of the first and second electrode tabs 111 and 113 may be opposite to that of the first and second electrode tabs 121 and 123 with respect to an x axis. For example, the lead out direction of the first and second electrode tabs 111 and 113 may be a positive y (+y) axis direction, and the lead out direction of the first and second electrode tabs 121 and 123 may be a −y axis direction.

The lead out directions of the electrode tabs 111, 113, 121, and 123 of FIG. 6 are changed from those of the electrode tabs 111, 113, 121, and 123 of FIG. 4. As described above, long side surfaces 110a and 120a of the first and second electrode assemblies 110 and 120 may have a square shape with identical four sides, and side walls of first and second pouch cases 130a and 130b may have the same length. Thus, the lead out direction of the first and second electrode tabs 111 and 113 of the first electrode assembly 110 and the lead out direction of the first and second electrode tabs 121 and 123 of the second electrode assembly 120 out of the pouch case 130 can be efficiently changed.

As such, since the lead out directions of the electrode tabs 111, 113, 121, and 123 can be changed, connecting paths between a pouch type secondary battery 100 and loads receiving power from the pouch type secondary battery 100 can be more simplified.

Although one heat dissipating plate is disposed between the first and second electrode assemblies 110 and 120 according to the above embodiment, the present invention is not limited thereto, and thus, one or more additional heat dissipating plates may be provided. That is, each of the first and second electrode assemblies 110 and 120 includes a plurality of electrode assemblies as described above, and additional heat dissipating plates may be disposed between the electrode assemblies. For example, an additional heat dissipating plate may be disposed between neighboring ones of the electrode assemblies of the first electrode assembly 110, and an additional heat dissipating plate may be disposed between neighboring ones of the electrode assemblies of the second electrode assembly 120. In this case, heat dissipating leads may be extended from the additional heat dissipating plates, respectively, and be exposed out of the pouch case 130.

Hereinafter, a pouch type secondary battery will now be described according to another embodiment.

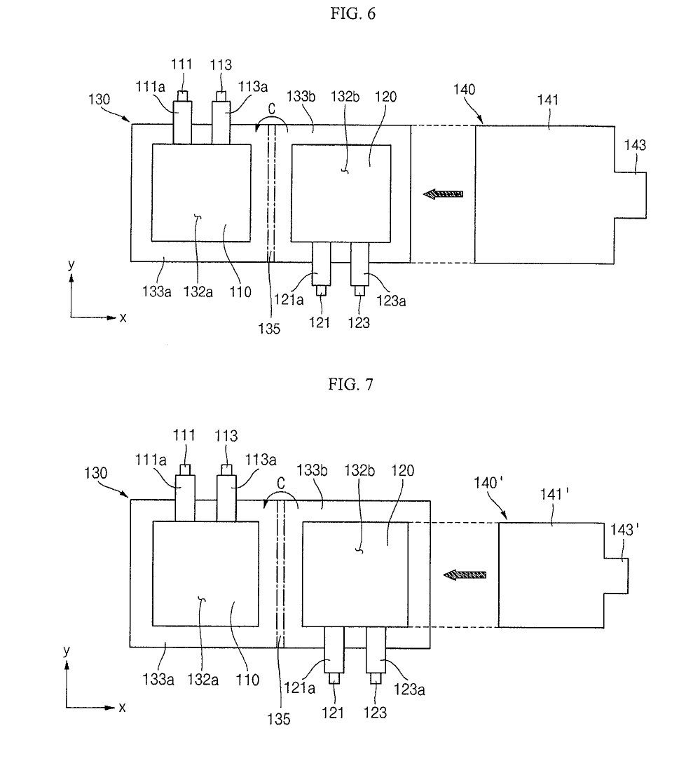

FIG. 8 is a plan view illustrating a pouch type secondary battery according to another embodiment.

Referring to FIG. 8, a pouch type secondary battery 800 according to the current embodiment includes a first electrode assembly 810, a second electrode assembly 820, a plurality of electrode tabs 811, 813, 821, and 823, a pouch case 830, and a heat dissipating member 840.

The first electrode assembly 810, the second electrode assembly 820, the electrode tabs 811, 813, 821, and 823, and the pouch case 830 are the same as the first electrode assembly 110, the second electrode assembly 120, the electrode tabs 111, 113, 121, and 123, and the pouch case 130, but the heat dissipating member 840 is different from the heat dissipating member 140 and 140′.

Thus, a detailed description of the first electrode assembly 810, the second electrode assembly 820, the electrode tabs 811, 813, 821, and 823, and the pouch case 830 is represented by the detailed description of the first electrode assembly 110, the second electrode assembly 120, the electrode tabs 111, 113, 121, and 123, and the pouch case 130, and the heat dissipating member 840 will now be described in more detail.

The heat dissipating member 840 may include a heat dissipating plate 841 and a heat dissipating lead 843.

The heat dissipating plate 841 has an approximately tetragonal plate shape, and the heat dissipating lead 843 may horizontally extend from an end of the heat dissipating plate 841. The heat dissipating member 840 may be formed of copper, aluminum, or an alloy thereof, and be coated with an insulating material.

The heat dissipating member 840 may have an area that is smaller (or may be smaller in area) than the long side surface of each of the first and second electrode assemblies 810 and 820, and be disposed between the long side surfaces of the first and second electrode assemblies 810 and 820. Unlike in the previous embodiment, the heat dissipating lead 843 is not exposed out of the pouch case 830, and may be extended from an end of the heat dissipating plate 841 and be connected to one of the first and second electrode assemblies 810 and 820 within the pouch case 830. For example, the heat dissipating lead 843 may be connected to the electrode tab 823 (also, referred to as a second electrode tab) of the second electrode assembly 820. In this case, when a second insulating tape 823a is attached to the second electrode tab 823, a portion of the second insulating tape 823a is removed to connect (e.g., to physcially contact) the second electrode tab 823 to the heat dissipating lead 843. Resistance welding may be used to connect the second electrode tab 823 to the heat dissipating lead 843.

As such, the heat dissipating lead 843 is not exposed out of the pouch case 830, and is connected to one electrode tab within the pouch case 830, unlike in the previous embodiment. Thus, even though heat generated from the first and second electrode assemblies 810 and 820 is not directly emitted out of the pouch case 830 through the heat dissipating lead 843, the heat is emitted through an electrode tab exposed out of the pouch case 830.

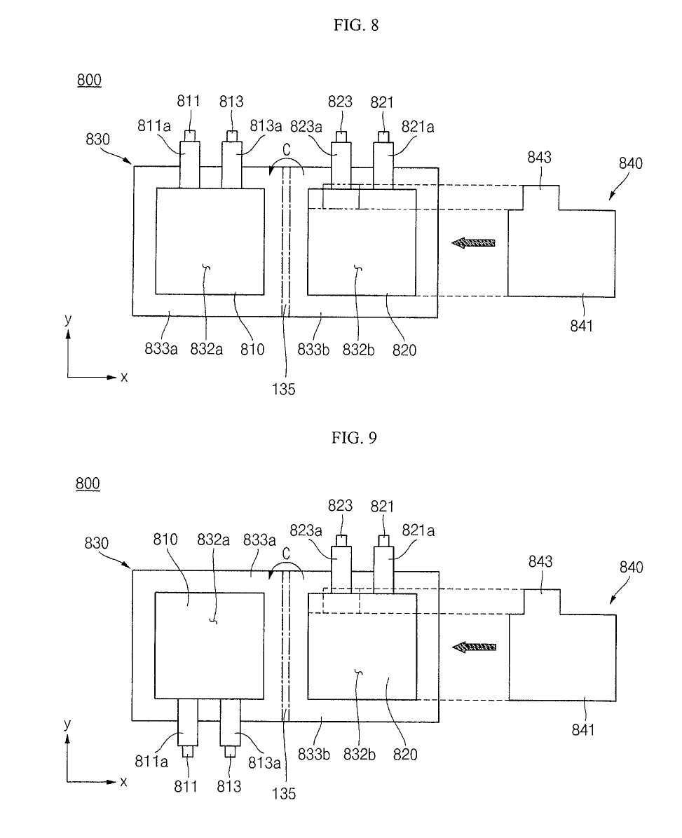

FIG. 9 is a plan view illustrating a modified example of the lead out directions of the electrode tabs of FIG. 8. More particularly, referring FIG. 9, a lead out direction of first and second electrode tabs 811 and 813 of a first electrode assembly 810 is different from that of first and second electrode tabs 821 and 823 of a second electrode assembly 820.

When the first and second electrode assemblies 810 and 820 are accommodated in a pouch case 830, the lead out direction of the first and second electrode tabs 811 and 813 may be opposite to that of the first and second electrode tabs 821 and 823 with respect to an x axis. For example, the lead out direction of the first and second electrode tabs 811 and 813 may be a −y axis direction, and the lead out direction of the first and second electrode tabs 821 and 823 may be a y axis direction.

That is, the lead out direction of the first and second electrode tabs 811 and 813 of FIG. 8, which is the y axis direction, is changed into the lead out direction of the first and second electrode tabs 811 and 813 of FIG. 9, which is the −y axis direction. As in the previous embodiment, long side surfaces of the first and second electrode assemblies 810 and 820 may have a square shape with identical four sides, and side walls of the pouch case 830 may have the same length. Thus, the lead out directions of the electrode tabs 811, 813, 821, and 823 can be efficiently changed.

Although one heat dissipating plate is disposed between the first and second electrode assemblies 810 and 820 according to the above embodiment, the present invention is not limited thereto, and thus, one or more additional heat dissipating plates may be provided. That is, each of the first and second electrode assemblies 810 and 820 includes a plurality of electrode assemblies as described above, and additional heat dissipating plates may be disposed between the electrode assemblies. For example, an additional heat dissipating plate may be disposed between neighboring ones of the electrode assemblies of the first electrode assembly 810, and an additional heat dissipating plate may be disposed between neighboring ones of the electrode assemblies of the second electrode assembly 820.

According to embodiments, heat dissipating performance of a pouch type secondary battery is improved.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims, and equivalents thereof.

What is claimed is:

1. A pouch type secondary battery comprising:
a plurality of electrode assemblies each having a pair of long side surfaces and a pair of short side surfaces each connecting two side portions of the long side surfaces, one of the pair of long side surfaces of one of the electrode assemblies and another one of the pair of long side surfaces of another one of the electrode assemblies facing each other;
a pouch case accommodating the electrode assemblies;
a plurality of electrode tabs electrically connected to the electrode assemblies, and exposed out of the pouch case; and
a heat dissipating member comprising at least one heat dissipating plate disposed between the one of the pair of long side surfaces of the one of the electrode assemblies and the other one of the pair of long side surfaces of the other one of the electrode assemblies, and a heat dissipating lead extending from the heat dissipating plate.

2. The pouch type secondary battery as claimed in claim 1, wherein the heat dissipating lead is configured to be connected to a heat sink disposed out of the pouch case.

3. The pouch type secondary battery as claimed in claim 1, wherein the electrode assemblies comprise:
a first electrode assembly comprising neighboring ones of the electrode assemblies; and
a second electrode assembly comprising another neighboring ones of the electrode assemblies.

4. The pouch type secondary battery as claimed in claim 3, wherein the pouch case comprises:
a first case having an opening and an inner space for accommodating the first electrode assembly;
a first sealing part extending outward along a periphery of an end of the first case;
a second case having an opening and an inner space for accommodating the second electrode assembly; and
a second sealing part extending outward along a periphery of an end of the second case,
wherein ends of the first and second sealing parts are connected to each other through a connecting part, and are bent such that the first sealing part corresponds to and faces the second sealing part.

5. The pouch type secondary battery as claimed in claim 4, wherein the heat dissipating plate has substantially the same area as that of an imaginary plane sharing an outer contour of the first or second sealing part.

6. The pouch type secondary battery as claimed in claim 3, wherein the electrode tabs connected to the first electrode assembly and the electrode tabs connected to the second electrode assembly are exposed in the same direction, and are electrically connected to each other such that the first electrode assembly and the second electrode assembly are connected to each other in parallel.

7. The pouch type secondary battery as claimed in claim 3, wherein the electrode tabs connected to the first electrode assembly are exposed in a direction different from that of the electrode tabs connected to the second electrode assembly.

8. The pouch type secondary battery as claimed in claim 1, wherein the heat dissipating plate has substantially the same area as that of the long side surface of each of the electrode assemblies.

9. The pouch type secondary battery as claimed in claim 1, wherein a lead out direction of the electrode tabs is different from an extension direction of the heat dissipating lead.

10. The pouch type secondary battery as claimed in claim 1, wherein the heat dissipating plate tightly contacts the one of the pair of long side surfaces of the one of the electrode assemblies and the other one of the pair of long side surfaces of the other one of the electrode assemblies.

11. The pouch type secondary battery as claimed in claim 1, wherein the heat dissipating plate is formed of copper, aluminum, or an alloy thereof, and is coated with an insulating material.

12. The pouch type secondary battery as claimed in claim 1, wherein the heat dissipating lead is exposed out of the pouch case.

13. A pouch type secondary battery comprising:
a plurality of electrode assemblies each having a pair of long side surfaces and a pair of short side surfaces each connecting two side portions of the long side surfaces, one of the pair of long side surfaces of one of the electrode assemblies and another one of the pair of long side surfaces of another one of the electrode assemblies facing each other;
a pouch case accommodating the electrode assemblies;
a plurality of electrode tabs electrically connected to the electrode assemblies, and exposed out of the pouch case; and
a heat dissipating member comprising at least one heat dissipating plate disposed between the one of the pair of long side surfaces of the one of the electrode assemblies and the other one of the pair of long side surfaces of the other one of the electrode assemblies, and a heat dissipating lead connecting the heat dissipating plate to at least one of the electrode tabs.

14. The pouch type secondary battery as claimed in claim 13, wherein the electrode assemblies comprise:
a first electrode assembly comprising neighboring ones of the electrode assemblies; and
a second electrode assembly comprising another neighboring ones of the electrode assemblies.

15. The pouch type secondary battery as claimed in claim 14, wherein the pouch case comprises:
a first case having an opening and an inner space for accommodating the first electrode assembly;
a first sealing part extending outward along a periphery of an end of the first case;
a second case having an opening and an inner space for accommodating the second electrode assembly; and
a second sealing part extending outward along a periphery of an end of the second case,
wherein ends of the first and second sealing parts are connected to each other through a connecting part, and are bent such that the first sealing part corresponds to and faces the second sealing part.

16. The pouch type secondary battery as claimed in claim 14, wherein the electrode tabs connected to the first electrode assembly and the electrode tabs connected to the second electrode assembly are exposed in the same direction, and are electrically connected to each other such that the first electrode assembly and the second electrode assembly are connected to each other in parallel.

17. The pouch type secondary battery as claimed in claim 14, wherein the electrode tabs connected to the first electrode assembly are exposed in a direction different from that of the electrode tabs connected to the second electrode assembly.

18. The pouch type secondary battery as claimed in claim 13, wherein the heat dissipating member is smaller in area than that of the long side surface of each of the electrode assemblies.

19. The pouch type secondary battery as claimed in claim 13, wherein the heat dissipating member tightly contacts the one of the pair of long side surfaces of the one of the electrode assemblies and the other one of the pair of long side surfaces of the other one of the electrode assemblies.

20. The pouch type secondary battery as claimed in claim 13, wherein the heat dissipating member is formed of copper, aluminum, or an alloy thereof, and is coated with an insulating material.
